(19) United States
(12) Patent Application Publication
(10) Pub. No.: US 2012/0030479 A1
(43) Pub. Date: Feb. 2, 2012

(54) STORAGE APPARATUS, HOST APPARATUS, AND STORAGE SYSTEM

(75) Inventors: Munetake Ebihara, Kanagawa (JP); Hiroshi Kuno, Kanagawa (JP); Takamichi Hayashi, Tokyo (JP); Kenjiro Ueda, Kanagawa (JP)

(73) Assignee: SONY CORPORATION, Tokyo (JP)

(21) Appl. No.: 13/187,714

(22) Filed: Jul. 21, 2011

(30) Foreign Application Priority Data
Jul. 28, 2010 (JP) 2010-169127

(51) Int. Cl. G06F 21/22

(52) U.S. Cl. 713/189

(57) ABSTRACT

Disclosed herein is a storage apparatus including: a first storage block configured to record and hold encrypted content data and output the encrypted content data on an on-demand basis; a second storage block configured to record and hold a confidential title key; a title stream key generation block configured to generate a title stream key corresponding to a subject of encryption of the content data by use of the held confidential title key; and a communication block configured to transmit the generated title stream key with confidentiality thereof held.

### CROSS REFERENCES TO RELATED APPLICATIONS

The present application claims priority to Japanese Priority Patent Application JP 2010-169127 filed in the Japan Patent Office on Jul. 28, 2010, the entire content of which is hereby incorporated by reference.

### BACKGROUND

The present application relates to a storage apparatus, a host apparatus, and a storage system that provide removable media having a content copy protect function.

In copy protection systems using remove media such as Blu-ray disc, DVD, or semiconductor memory, encrypted content such as video for example is encrypted with a title key that is data as small as 16 bytes wide.

Only those copy protection systems which are permitted in license can handle such a title key.

### SUMMARY

However, there is a problem that, as compared with hardware products robust in the handling of content keys that are confidential values, it is relatively easy to expose title keys in PC (Personal Computer) software products.

In related-art copy protection systems, a title key that is a small amount of data is also passed to an encrypted content player/recorder realized by PC software without differentiating this product from robust ones.

As a result, referencing a very tiny memory area of the PC software allows the discovery and exposure of a title key.

The title key thus exposed, which has a very compact value, can easily be published on a bulletin board or incorporated in a malicious software, for example.

Such a title-key exposure has been causing many events that invalidate the encryption of two or more recording media like Blu-ray disc media having a same title encrypted by the exposed title.

Therefore, the present application addresses the above-identified and other problems associated with related-art methods and apparatuses and solves the addressed problems by providing a storage apparatus, a host apparatus, and a storage system that are configured to prevent title keys from being discovered and exposed by attacks on host products.

In carrying out the application and according to a first mode thereof, there is provided a storage apparatus. This storage apparatus has a first storage block configured to record and hold encrypted content data and output the encrypted content data on an on-demand basis; a second storage block configured to record and hold a confidential title key; a title stream key generation block configured to generate a title stream key corresponding to a subject of encryption of the content data by use of the held confidential title key; and a communication block configured to transmit the generated title stream key with confidentiality thereof held.

In carrying out the application and according to a second mode thereof, there is provided a host apparatus. This host apparatus has a communication block configured to be communicable with a storage apparatus and receive encrypted content data outputted from the storage apparatus in a communication ready state and a title stream key corresponding to the subject of encryption of the content data with confidentiality of the title stream key held; and a decryption block configured to execute decryption by use of the received encrypted content data and the title stream key received with confidentiality of the title stream key held.

In carrying out the application and according to a third mode thereof, there is provided a storage system. This storage system has a storage apparatus and a host apparatus communicable with the storage apparatus. This storage apparatus has a first storage block configured to record and hold encrypted content data in advance and output the encrypted content data on an on-demand basis, a second storage block configured to record and hold a confidential title key, a first title stream key generation block configured to generate a title stream key corresponding to the subject of encryption of the content data by use of the held confidential title key, and a first communication block configured to transmit the generated title stream key with the confidentiality thereof held.

As described above and according to embodiments of the application, the discovery and exposure of a title key can be prevented in an attack on host products.

Additional features and advantages are described herein, and will be apparent from the following Detailed Description and the figures.

### BRIEF DESCRIPTION OF THE FIGURES

FIG. 1 is a schematic block diagram illustrating an outline configuration of a storage system practiced as one embodiment of the application;

FIG. 2 is a sequence chart indicative of a basic communication sequence to be executed between a host apparatus and a storage apparatus practiced as embodiments of the application;

FIG. 3 is a schematic diagram illustrating a first example of a transmission/reception operation of a title key and content data corresponding thereto between the host apparatus and the storage apparatus;

FIG. 4 is a schematic diagram illustrating a second example of a transmission/reception operation of a title key and content data corresponding thereto between the host apparatus and the storage apparatus;

FIG. 5 is a schematic diagram illustrating a third example of a transmission/reception operation of a title key and content data corresponding thereto between the host apparatus and the storage apparatus;

FIGS. 6A and 6B are schematic diagrams illustrating a fourth example of a transmission/reception operation of a title key and content data corresponding thereto between the host apparatus and the storage apparatus; and

FIG. 7 is a schematic diagram illustrating a fifth example of a transmission/reception operation of a title key and content data corresponding thereto between the host apparatus and the storage apparatus.

### DETAILED DESCRIPTION

Embodiments of the present application will be described below in detail with reference to the drawings.

(1) an overall outline configuration of a storage system; and

(2) a communication sequence between a host apparatus and a storage apparatus.

(1) An Overall Outline Configuration of a Storage System

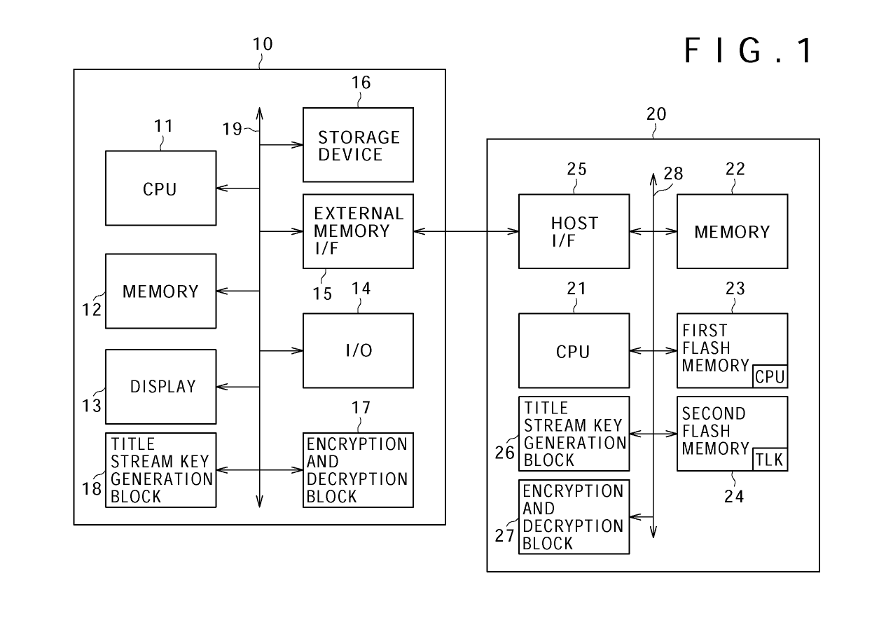

Now, referring to FIG. 1, there is shown an outline configuration of a storage system practiced as one embodiment of the present application.

As shown in FIG. 1, the storage system has a host apparatus 10 and a storage apparatus (or a memory apparatus) 20 that is detachably loaded on the host apparatus 10 as main configurational elements. In the present embodiment, the storage apparatus 20 has a flash memory that is one of non-volatile memories.

In the storage system according to the present embodiment, the storage apparatus 20 has a function of authenticating the host apparatus 10 and has a title stream encryption key generation block for generating a substantially the same title stream key as content data from a small title key.

In the case of a host apparatus not allowed to have the title key and the title stream encryption key generation block, such a host apparatus is allowed to execute authentication to receive a title stream key but cannot know the title key.

To be more specific, in the storage system (or the memory system) according to the present embodiment, the storage apparatus 20 and the host apparatus 10 have following characteristic configurations.

To be more specific, the storage apparatus 20 has a first storage block for recording encrypted content data and holding the recorded encrypted content data and outputting the held encrypted content data upon a read request and a second storage block for recording a confidential title key and holding the recorded confidential title key.

The storage apparatus 20 includes a first title stream key generation block that uses the held confidential title key to generate, in accordance with a subject of encryption of content data, a title stream key having the same size as this subject of encryption of content data for example.

The storage apparatus 20 includes a first communication block that executes transmission with the confidentiality of the generated title stream key held.

The storage apparatus 20 includes a control block that securely distinguishes, by means of authentication, a host apparatus permitted to hold the title stream key generation block and transmits the held confidential title key only to the host apparatus permitted to hold the title stream key generation block.

In addition, the storage apparatus 20 is capable of having a title key generation block for newly generating a confidential title key by instruction given from the outside.

The storage apparatus 20 is also capable of having a function for recording, to the second storage block, a confidential title key transferred by the control block from the host apparatus 10 with confidentiality held, thereby holding the recorded confidential title key in the second storage block.

The host apparatus 10 has a second communication block for providing communication with the storage apparatus 20.

The second communication block has a function of encrypted receiving content data read from the storage apparatus 20 in a communication enabled state and a title stream key having the same size as that of a subject of encryption of the content data with confidentiality held.

The host apparatus 10 includes a decryption block for execute decryption by use of the encrypted content data received by the second communication block and the title stream key received with confidentiality held.

This decryption block decrypts the confidentiality of the title stream key to decrypt the content data by use of the decrypted title stream key.

The host apparatus 10 can also have a second title stream key generation block that, by use of a confidential title key, generates a title stream key having the same size as that of a subject of encryption of content data.

Further, the decryption block is capable of executing decryption by use of the encrypted content data read from the storage apparatus 20 and the title stream key generated by the title stream key generation block.

The host apparatus 10 is also capable of encrypting plain content for example to be protected by use of a title stream key received from the host apparatus 10 with confidentiality held and transmitting the encrypted content data to the storage apparatus 20 via the second communication block, recording the transmitted content data to the storage apparatus 20.

In addition, the second communication block includes a function of transmitting a confidential title key with the confidentiality held in the storage apparatus 20.

Then, the encryption block may have a configuration in which the encryption block generates a title stream key on the basis of a certain title key to encrypt the content data to be protected by use of the generated title stream key, thereby transmitting the encrypted content data to the second communication block as appropriate.

The following describes specific configurations and functions of the storage apparatus 20 and the host apparatus 10.

The host apparatus 10 is made up of electronic devices, such as a personal computer (PC) that is communicable with the storage apparatus 20.

The host apparatus 10 has a CPU 11 as a first control block, a memory 12, a display 13, an input/output processing block 14, and an external memory I/F (Interface) 15 as the second communication block.

The host apparatus 10 has a storage device 16 for storing content data and so on.

In addition, the host apparatus 10 has an encryption/decryption block 17 that provides encryption and decryption functions mentioned above.

The host apparatus 10 may include a second title stream key generation block 18 for generating a title stream key having the same size as that of a subject of encryption of content data by use of a confidential title key.

The CPU 11 is interconnected with the memory 12, the display 13, the I/O processing block 14, the external memory I/F 15, the storage device 16, the encryption and decryption block 17, and the second title stream key generation block 18 via a bus 19.

The memory 12 has a ROM for storing programs, a RAM for providing a work area, and so on. The external memory I/F 15 that is the second communication block transfers data with the storage apparatus 20 in accordance with control instructions given by the CPU 11.

The encryption and decryption block 17 executes decryption by use of the encrypted content data received by the external memory I/F 15 that is the second communication block and the title stream key received with confidentiality held.

This encryption and decryption block 17 decrypts the confidentiality of the title stream key and then decrypts the content data by use of the decrypted title stream key.

The encryption and decryption block 17 is capable of executing decryption by use of the encrypted content read from the storage apparatus 20 and the title stream key generated by the title stream key generation block.

The encryption and decryption block 17 encrypts plain content data to be protected by use of a title stream key received from the host apparatus 10 with confidentiality held and transmits the encrypted content data to the storage apparatus 20 via the external memory I/F 15.

The external memory I/F 15 includes a function of transmitting a confidential title key to the storage apparatus 20 with the confidentiality held.

Then, the encryption and decryption block 17 generates a title stream key on the basis of a certain title key, encrypts content data to be protected by use of this title stream key, and transmits the encrypted content data to the second communication block as appropriate.

The storage apparatus 20 has a CPU 21 that is a first control block, a memory 22, a first flash memory 23 that is a first storage block, a second flash memory that is a second storage block, and a host I/F 25 that is a first communication block.

The storage apparatus 20 has a title stream key generation block 26 and an encryption and decryption block 27.

The CPU 21 is interconnected to the memory 22, the first flash memory 23, the second flash memory 24, the host I/F 25, the title stream key generation block 26, and the encryption and decryption block 27 via a bus 28.

The memory 22 has a ROM for storing programs and a RAM for providing a work area, for example.

The first flash memory 23 functions as the first storage block and is made up of a NOR-type or NAND-type flash memory (a non-volatile memory).

The first flash memory 23 records and holds encrypted content data (content file) CTD with expiration managed. This content data CTD is a mass data of 50 gigabytes (GB) for example.

The second flash memory 24 functions as the second storage block and is made up of a NOR-type or NAND-type flash memory (a non-volatile memory).

The second flash memory 24 holds an encrypted title key (TLK) of 16 bytes for example. This encrypted title key TLK is 16 bytes wide that is far smaller than the mass data of 50 gigabytes (GB) of content data CTD.

The host I/F 25 that is the first communication block transfers data with the host apparatus 10 in accordance with control instructions given by the CPU 21.

The title stream key generation block 26 generates a title stream key TLSRMK having the same size as that of the content data CTD recorded to the first flash memory 23 from the title key TLK recorded to the second flash memory 24.

Under the control of the CPU 21, the encryption and decryption block 27 encrypts the title stream key TLSRMK generated by the title stream key generation block 26 and transmits the encrypted title stream key TLSRMK to the host apparatus 10 via the host I/F 25.

The encryption and decryption block 27 decrypts the encrypted content data CTD recorded to the first flash memory 23 and the encrypted content data and the encrypted title stream key received from the host apparatus 10.

The title stream key generation block 26 has the following functions, for example.

The title stream key generation block 26 can generate a title stream key TLSRMK having the same size as that of the subject of encryption of content data CTD on the basis of a title key TLK and a certain value.

For example, if 80% of content data (a file) of 50 GB in size is to be encrypted, the title stream key generation block 26 can generate a title stream key TLSRMK for at least 40 GB.

Giving a title key TLK and a parameter as appropriate to an encryptor (in the encryption and decryption block 27) allows the title stream key generation block 26 to generate a title stream key TLSRMK.

For such an encryptor, the AES CTR mode may be used.

For a parameter to be given in addition to a title key, a file offset, a counter value in content, or a packet header may be used, for example.

It should be noted that the function of executing of decryption by use of encrypted content data and an encrypted title stream and the function of encrypting plain content data to be protected with a title stream key can be realized as follows, for example.

To be more specific, the above-mentioned functions can be realized by executing an XOR (Exclusive OR) between the content data and the title stream key.

The host I/F 25 that is the first communication block has a function of transferring data with the host apparatus 10 under the control of the CPU 21 and a function of transmitting a generated title stream key TLSRMK to the host apparatus 10 with the confidentiality held.

The function of the transmission with the confidentiality held includes the following for example.

To be more specific, the function of transmission with the confidentiality held includes a communication path in which the confidentiality can be physically held, an optical fiber protected in a robust manner for example, and a communication path encrypted by a session key (or bus key) or a predetermined key based on authentication technologies.

It should be noted that the title stream key generation block and the function of transmission with the confidentiality held described above can be installed on the host apparatus 10 without changing the configurations and functions of these block and function.

The CPU 21 that is the control block includes functions of securely distinguishing the host apparatus permitted to hold the title stream key generation block and transmitting the held confidential title key only to the host apparatus permitted to hold the title stream key generation block.

The functions of securely distinguishing a host product permitted to hold the stream key generation block from a host product not permitted to hold the stream key generation block are as follows, for example.

The function of making each host apparatus hold a different authentication key.

The function of giving a different attribute to the certificate that can be validated by a public key passed to each host apparatus.

The function of implementing the physical interface between each host apparatus and each storage apparatus by a technology (a sophisticated blue laser for example) that is robust against falsification.

A storage media device that forms the storage apparatus 20 is as follows for example.

The storage apparatus 20 is formed by an optical media or an optical media drive.

The optical media includes a ROM media for holding encrypted content data and a confidential title key and rewritable media and recordable media.

The optical media drive includes a flash memory card, a USB memory, and a copyright-protection compatible HDD that have each a stream key generation device and confidentially transfer a stream key by authentication with the host by use of encryption, for example.

It is also practicable to employ a configuration in which both functions of optical media and optical media drive are unitized; physically, a flash memory or an HDD is applicable to this configuration.

The host product that forms the host apparatus 10 includes the following, for example.

The host apparatus 10 is formed by a media player/recorder device, a Blu-ray player/recorder, an HDD recorder, a PC Blu-ray/DVD recorder/player software, and a KIOSK server and terminal.

The host product that is not allowed to hold a stream key generation device includes the following, for example.

PC Blu-ray/DVD recorder/player software for example.

(2) Communication (Authentication) Sequence between Host Apparatus and Storage Apparatus

The following describes a communication (authentication) sequence to be executed between the host apparatus 10 and the storage apparatus 20 of the present embodiment.

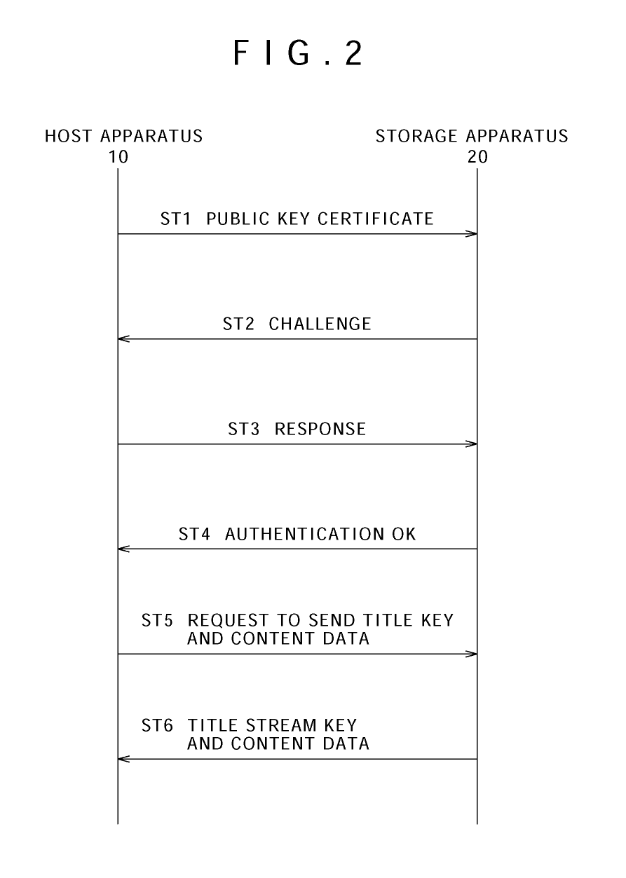

Referring to FIG. 2, there is shown a basic communication sequence to be executed between the host apparatus 10 and the storage apparatus 20 of the present embodiment.

In the storage system according to the present embodiment, authentication and key exchange are executed between the host apparatus 10 and the storage apparatus 20, for example, which is processed in accordance with a protocol for sharing a bus key.

In this storage system, the authentication between the host apparatus 10 and the storage apparatus 20 is executed by the challenge and response method.

In this storage system, the key exchange between the host apparatus 10 and the storage apparatus 20 is executed by the ECDH (Elliptic Curve Diffie-Hellman) method.

Step ST1

In step ST1, the host apparatus 10 transmits a public key certificate for example to the storage apparatus 20.

The storage apparatus 20 verifies the public key certificate by the public key of the certification authority.

The storage apparatus 20 securely distinguishes whether the host apparatus 10 is a host apparatus that is allowed to hold the title stream key generation block from access control information (or attribute information) in the public key certification.

Step ST2

In step ST2, the storage apparatus 20 transmits a challenge (or a pseudo random number) to the host apparatus 10.

Step ST3

In step ST3, the host apparatus 10 transmits a response (or a value obtained by encrypting the challenge by the confidential key of the host apparatus 10) to the storage apparatus 20.

Step ST4

In step ST4, the storage apparatus 20 decrypts the response by the public key of the host apparatus 10 to confirm whether there is a match with the value transmitted by the challenge. If a match is found, the storage apparatus 20 notifies the host apparatus 10 of a successful authentication.

Step ST5

In step ST5, the host apparatus 10 issues a request-to-send to the storage apparatus 20 for a title key to be obtained and content data corresponding thereto.

Step ST6

In step ST6, in response to the request-to-send for a title key and content data corresponding thereto, the storage apparatus 20 executes the processing corresponding to the decision result obtained in step ST1.

To be more specific, if the host apparatus 10 is found to be a host apparatus allowed to hold the title stream key generation block, then the storage apparatus 20 transmits the title key and the content data corresponding thereto to the host apparatus 10.

The following describes a specific example of transmission and reception operations for a title key and content data corresponding thereto.

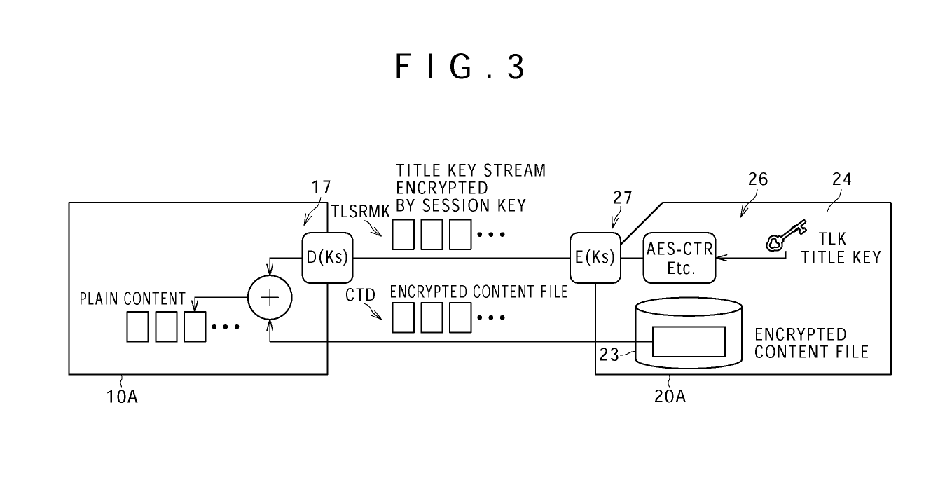

Referring to FIG. 3, there is shown a first example of operations of transmission and reception of a title key and content data corresponding thereto between a host apparatus and a storage apparatus.

The example shown in FIG. 3 shows operations of transmission and reception of a title key and content data corresponding thereto between the host apparatus that is a PC host player and the storage apparatus that is a memory card.

In the example shown in FIG. 3, a title stream key generation block 26 of a storage apparatus 20A generates, from a title key TLK, a title stream key TLSRMK having the same size as that of content data CTD recorded to the first flash memory 23.

Then, under the control of the CPU 21, an encryption and decryption block 27 encrypts the title stream key TLSRMK generated by the title stream key generation block 26 and transmits the encrypted title stream key TLSRMK to the host apparatus 10A via a host I/F 25.

At this moment, the encrypted content data CTD recorded to the first flash memory 23 is also transmitted to the host apparatus 10A.

In the host apparatus 10A, the title stream key TLSRMK received from the storage apparatus 20 is decrypted by the encryption and decryption block 17.

Next, by use of the title stream key TLSRMK decrypted by the encryption and decryption block 17, the content data received by executing an XOR operation for example is decrypted.

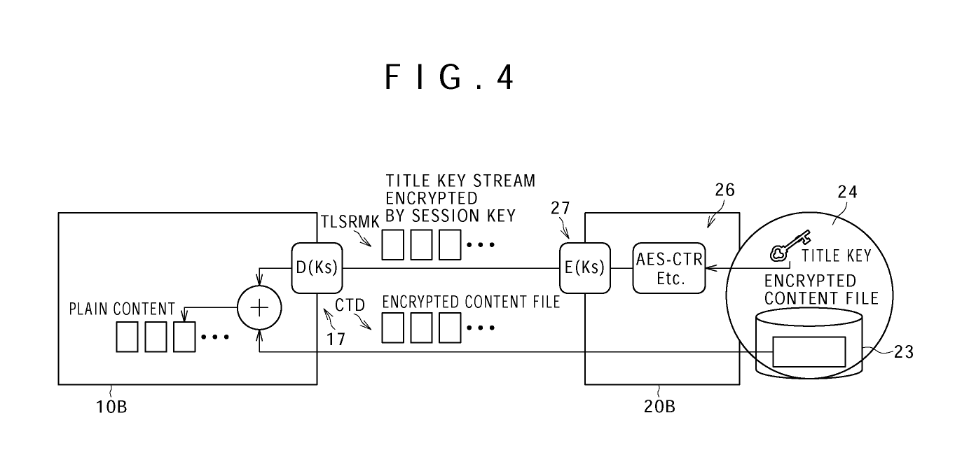

Referring to FIG. 4, there is shown the second example of operations of transmission and reception of a title key and content data corresponding thereto between a host apparatus and a storage apparatus.

The second example shown in FIG. 4 differs from the first example shown in FIG. 3 in that a storage apparatus 20B is formed by an optical media drive.

The other configurations of the second example are substantially the same as those of the first example and the basic operations of the second example are substantially the same as those of the first example, so that the description of the second example is skipped.

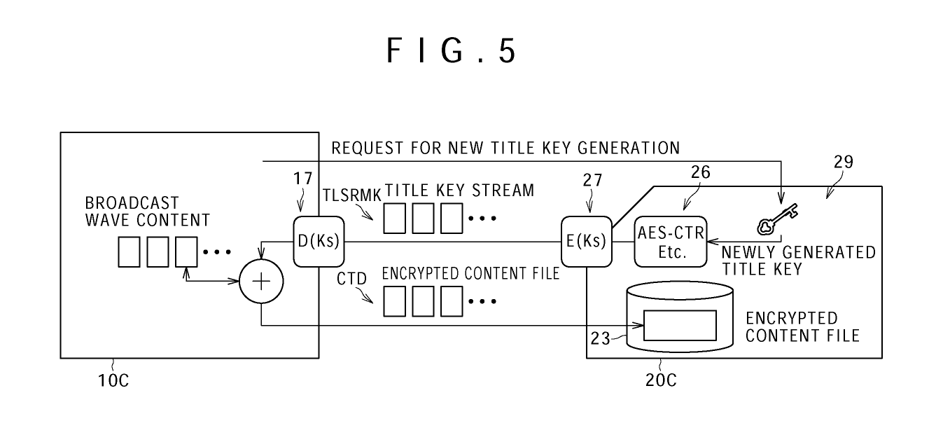

Referring to FIG. 5, there is shown a third example of operations of transmission and reception of a title key and content data corresponding thereto between a host apparatus and a storage apparatus.

The third example shown in FIG. 5 differs from the first example shown in FIG. 3 in the following points.

In the third example, a host apparatus 10C is formed by a PC host recorder and a storage apparatus 20C is an external storage. In the storage apparatus 20C, when a request for generating a new title key comes from the host apparatus 10C, a title key generation block 29 generates the requested title key. The generated title key is stored in the second flash memory 24.

In the third example, the other configurations are substantially the same as those of the first example and the basic operations of the second example are substantially the same as those of the first example, so that the description of the third example is skipped.

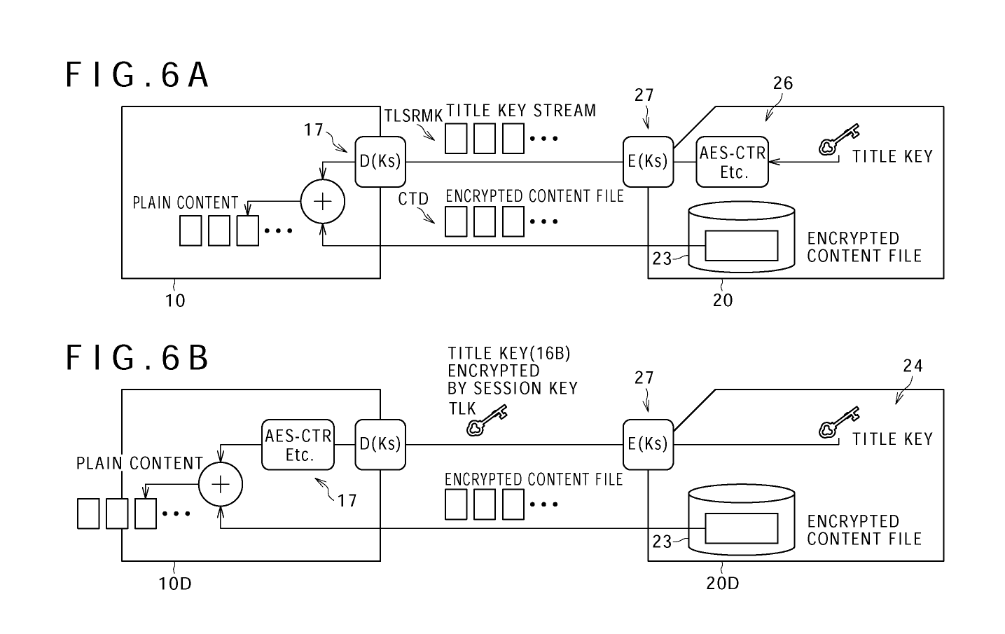

FIG. 6A and FIG. 6B show the fourth example of operations of transmission and reception of a title key and content data corresponding thereto between a host apparatus and a storage apparatus.

The example shown in FIG. 6A is substantially the same as the first example shown in FIG. 3.

In the fourth example, as shown in FIG. 6B, if a host apparatus 10D is other than a PC host, a CE host player for example, the generation of a title stream key TLSRMK that is one of the features of the present application is not executed in a host storage 20D.

In this case, a normal title key of 16 bytes wide for example is encrypted to be transmitted to the host apparatus 10D.

At this moment, encrypted content data CTD recorded to the first flash memory 23 is also transmitted to the host apparatus 10D.

In the host apparatus 10D, a encryption and decryption block 17 decrypts the normal title key TLK received from the 20D.

Then, by use of the title key TLK decrypted by the encryption and decryption block 17, the content data received by executing an XOR operation for example is decrypted.

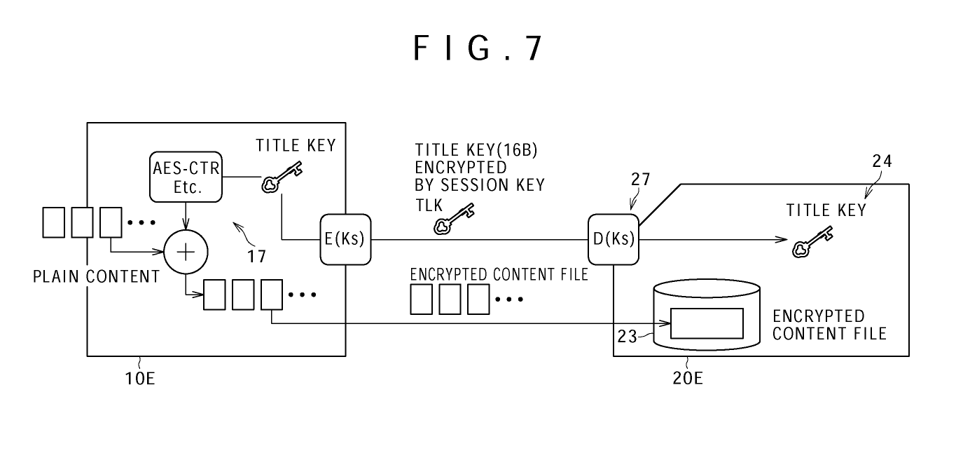

Referring to FIG. 7, there is shown a fifth example of operations of transmission and reception of a title key and content data corresponding thereto between a host apparatus and a storage apparatus.

In the fifth example, a host apparatus 10E is formed by a MOD/EST server, such as KIOSK for example, a storage apparatus 20E is formed by a memory card for example like the first example.

An encryption and decryption block 17 of the host apparatus 10E encrypts content data by use of a title key TLK of 16 bytes wide for example and also this title key TLK, both the encrypted content data and title key TLK being transmitted to the storage apparatus 20E.

In the storage apparatus 20E, the received content data is recorded to the first flash memory 23 and the title key is decrypted by the encryption and decryption block 27 to be recorded to the second flash memory 24.

In this case, like a CE host player, a server is notified of a title stream key generation method.

As a result, content data (or a file) of EST, such as KIOSK for example, can be generated beforehand. Besides, re-encryption for example involved in the regular changing of title keys is not required.

It should be noted that a discrimination between a PC host and other hosts can be made by adding attribute “PC” or “Not PC” to the host certificate, for example.

Attribute “Not PC” includes a CE device, a server, and so on.

As described above, according to the present embodiment, the following effects are provided.

Host products, such as players/recorders based on PC software, are not provided with a title key and a stream encryption generator; instead, these title key and stream encryption generator can be otherwise installed on the drive or the media of removable media.

This novel configuration prevents the title key from being discovered and exposed in an attack on host products having neither title key nor stream encryption generator.

The values common to titles stored in a memory space of the PC software based on the embodiments of the present application are as follows.

To be specific, the title-common values stored in the memory space are only a decrypted content file (nearly 50 GB in the case of a Blu-ray disc), the encrypted content file before being decrypted (of the same size as that of the decrypted content file), and a title stream key (of the same size) used for the encryption.

Consequently, the size of a title-unique key becomes about 16 bytes to about 50 GB, so that only referencing a very small memory area cannot achieve the acquisition of a title key for decrypting encrypted content. This configuration prevents one of effective means of attacking PC software.

While preferred embodiments of the present application have been described using specific terms, such description is for illustrative purpose only, and it is to be understood that changes and variations may be made without departing from the spirit or scope of the following claims.

The above-mentioned methods described in detail can also be formed as computer programs corresponding to the above-mentioned procedures, these computer programs being executed by a computer including the CPU.

In addition, these computer programs can be configured so as to be provided as recorded to a semiconductor memory, a magnetic disk, an optical disk, a floppy disk (trademark), or other recording media to be accessed and executed by a computer on which these recording media are loaded.

It should be understood that various changes and modifications to the presently preferred embodiments described herein will be apparent to those skilled in the art. Such changes and modifications can be made without departing from the spirit and scope and without diminishing its intended advantages. It is therefore intended that such changes and modifications be covered by the appended claims.

The application is claimed as follows:

1. A storage apparatus comprising:
a first storage block configured to record and hold encrypted content data and output said encrypted content data on an on-demand basis;
a second storage block configured to record and hold a confidential title key;
a title stream key generation block configured to generate a title stream key corresponding to a subject of encryption of said content data by use of the held confidential title key; and
a communication block configured to transmit the generated title stream key with confidentiality thereof held.

2. The storage apparatus according to claim 1, further comprising:
a control block configured to discriminate, by executing authentication, a host apparatus allowed to hold a title stream key generation block and transmit the held confidential title key only to said host apparatus allowed to hold a title stream key generation block.

3. The storage apparatus according to claim 1, still further comprising:
a title key generation block configured to newly generate a confidential title key as instructed from outside.

4. The storage apparatus according to claim 1, yet further comprising:
a control block configured to record and hold, to said second storage block, the title key transferred from an external host apparatus with confidentiality of said title key held.

5. A host apparatus comprising:
a communication block configured to be communicable with a storage apparatus and receive encrypted content data outputted from the storage apparatus in a communication ready state and a title stream key corresponding to the subject of encryption of said content data with confidentiality of said title stream key held; and
a decryption block configured to execute decryption by use of said received encrypted content data and said title stream key received with confidentiality of said title stream key held.

6. The host apparatus according to claim 5, wherein
said decryption block decrypts the confidentiality of said title stream key to decrypt said content data by use of the decrypted title stream key.

7. The host apparatus according to claim 5, further comprising:
a title stream key generation block configured to generate a title stream key corresponding to a subject of encryption of content data by use of a confidential title key,
said decryption block executing decryption by use of said encrypted content data outputted from said storage apparatus and the title stream key generated by said title stream key generation block.

8. The host apparatus according to claim 5, still comprising:
an encryption block configured to encrypt content data to be protected by use of the title stream key received with the confidentiality of said title stream key held from said storage apparatus and transmit and record the encrypted content data to said storage apparatus via said communication block.

9. The host apparatus according to claim 5, wherein
said communication block has a function of transmitting a confidential title key to said storage apparatus with the confidentiality of said confidential title key held and
an encryption block configured to generate a title stream key on the basis of a certain title key to encrypt content data to be protected by use of the generated title stream key in advance, thereby transmitting the encrypted content data via said communication block as appropriate.

10. A storage system comprising:
a storage apparatus; and
a host apparatus communicable with said storage apparatus,
said storage apparatus having
a first storage block configured to record and hold encrypted content data in advance and output said encrypted content data on an on-demand basis,
a second storage block configured to record and hold a confidential title key,
a first title stream key generation block configured to generate a title stream key corresponding to the subject of encryption of said content data by use of the held confidential title key, and
a first communication block configured to transmit the generated title stream key with the confidentiality thereof held.

11. The storage system according to claim 10, wherein
said storage apparatus has
a control block configured to discriminate, by executing authentication, a host apparatus allowed to hold a title stream key generation block and transmit the held confidential title key only to said host apparatus allowed to hold a title stream key generation block.

12. The storage system according to claim 10, wherein
said storage apparatus has a title key generation block configured to newly generate a confidential title key as instructed from outside.

13. The storage system according to claim 10, wherein
said storage apparatus has a control block configured to record and hold, to said second storage block, the title key transferred from said host apparatus with confidentiality of said title key held.

14. The storage system according to claim 10, wherein
said host apparatus has a second communication block configured to be communicable with a storage apparatus and receive encrypted content data outputted from the storage apparatus in a communication ready state and a title stream key corresponding to the subject of encryption of said content data with confidentiality of said title stream key held; and
a decryption block configured to execute decryption by use of said received encrypted content data and said title stream key received with confidentiality of said title stream key held.

15. The storage system according to claim 14, wherein
said decryption block of said host apparatus decrypts the confidentiality of said title stream key to decrypt said content data by use of the decrypted title stream key.

16. The storage system according to claim 14, wherein
said host apparatus has a second title stream key generation block configured to generate a title stream key corresponding to a subject of encryption of content data by use of a confidential title key, and
said decryption block executes decryption by use of said encrypted content data outputted from said storage apparatus and the title stream key generated by said title stream key generation block.

17. The storage system according to claim 14, wherein
said host apparatus has an encryption block configured to encrypt content data to be protected by use of the title stream received with the confidentiality of said title stream key held from said storage apparatus and transmit and record the encrypted content data to said storage apparatus via said second communication block.

18. The storage system according to claim 14, wherein said second communication block of said host apparatus has a function of transmitting a confidential title key to said storage apparatus with the confidentiality of said confidential title key held, and
an encryption block configured to generate a title stream key on the basis of a certain title key to encrypt content data to be protected by use of the generated title stream key in advance, thereby transmitting the encrypted content data via said second communication block as appropriate.
